(19) United States
(12) Patent Application Publication
(10) Pub. No.: US 2003/0233741 A1
(43) Pub. Date: Dec. 25, 2003

(54) Artery and vein coupling

(76) Inventor: Thomas Aikens, Tampa, FL (US)

Correspondence Address: THOMAS AIKENS, 3106 E. LAKE AVE., TAMPA, FL, 33610, US

(21) Appl. No.: 10/174,471

(22) Filed: Jun. 19, 2002

(51) Int. Cl. A01N 1/00

(52) U.S. Cl. 27/22.1

(57) ABSTRACT

The A/V Coupling is new to the field of embalming because there is no device used in the field to aid the embalmer after the embalming process. There are powder and granule substances used to agglutinate liquid fluid in the body, but no device to adhere to the vessels to continue the natural flow of the fluids in the circulation system.

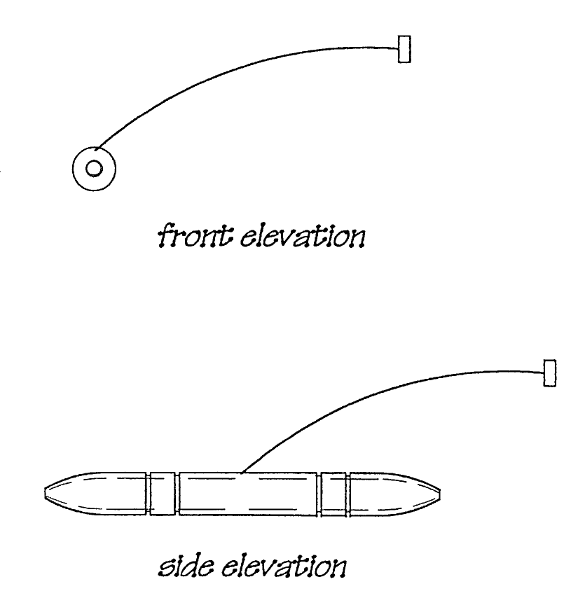

The A/V Coupling is used in the artery and vein system of human remains after the embalming process. After the process of arterial injections of chemicals and draining of fluids by the embalmer, the coupling with the guide is inserted through the incision into the vessel. The coupling has double ringed grooves on each end and has a hollow interior. The interior is hollow so that fluid may continue to pass through the vessel. The A/V Coupling is made from one of the polymers—nylon, polycarbonate, polyethylene and polyvinyl chloride. The A/V Coupling is 3 inches in length with a polymer guide director 3 inches in length and 1/16 inches outside diameter located in the center of the A/V Coupling. The outside diameters of the A/V Coupling are: ¾, 7/16, ⅚, 1//4, 3/6, ⅛ 3/32 and 1/16 of an inch.

### CROSS REFERENCE TO RELATED APPLICATIONS

Not Applicable

### STATEMENT REGARDING FEDERALLY SPONSORED RESEARCH OR DEVELOPMENT

Not Applicable

### REFERENCE TO A MICROFICHE APPENDIX

Not Applicable

### BACKGROUND OF THE INVENTION

The field of endeavor is the funeral industry generally, and more specifically the embalming process of human remains. In human beings, blood is forced to flow continuously through the human body by the powerful pumping action of the heart. The many tube like structures through which the blood flows, called arteries and veins make up the vascular system. After death, the heart can no longer perform its function. The embalming machine is employed and performs the functions once performed by the heart. The machine creates pressure in the body that forces the blood out of the arteries and veins. Embalming instruments are inserted into both arteries and veins to remove the blood from the deceased human body. The embalmer first makes an incision in both vessels. At this time there is an opening in both the artery and the vein. The A/V Coupling will then be put in place by inserting it into both vessels with the guide director. The A/V Coupling will allow the fluids which the embalming machine has injected under pressure to continuously flow to all parts of the body.

The purpose of the claimed invention is to prevent leakage and pressure in the human remains after the process of embalming. By using this invention it will solve the problem of leakage encountered by the embalmer. The only known and possibly related mechanism is the “shunt” which is used in the medical field on living humans. The only common use of the shunt is to continue the flow of fluids.

### BRIEF SUMMARY OF THE INVENTION

The general idea of the claimed invention is to aid the embalmer after the embalming process. It will ensure proper re-connection of the blood vessels to continue the proper flow of chemicals in the deceased's body. This will solve the problem of pressure build-up which could cause leakage.

### BRIEF DESCRIPTION OF THE SEVERAL VIEWS OF THE DRAWING

Not Applicable

### DETAILED DESCRIPTION OF THE INVENTION

The process of making the A/V Coupling is comprised of first a die of the coupling. Before a die is built, complete drawings and specifications of the coupling are required to guide the die maker. Each component must be measured and then fitted together, before testing for proper function. The die is a tool used in conjunction with an injection molding machine. The injection molding machine processes polymers of the thermoplastic material which is fed into a hopper, that is attached on the top of the machine and emerges as hot melt at the die. This process consists of heating and homogenizing plastic granules or polymers in a cylinder until there is sufficient fluid to allow for pressure injection into a relatively cold mold where they solidify and take the shape of the mold cavity or die. In the process of embalming, which is chemically treating the dead human body to reduce the presence and growth of microorganisms, to retard organic decomposition and to restore life-like appearance. The arteries and veins are used for this process by making an incision in both vessels and chemically treating the human remains. After this technique the A/V Coupling would be inserted in both artery and vein to prevent leakage of fluids and pressure build up in the body, which allows equal pressure to all parts of the human remains, this will keep swelling from occurring. There is no other product on the market in the funeral industry to compare with the A/V Coupling. The entire A/V Coupling is made from polymer, including the guide. Polymer is a chemical reaction in which a number of similar small molecules is called polymerization, and the macromolecular product is a polymer.

1. What I claim as my invention is a mechanism called the Artery and Vein Coupling which will prevent the leakage of embalming fluids because the hollow area in the tube structure will allow the continuous flow of fluids.

2. I claim my invention will also prevent the pressure build up in the body which causes swelling to occur. The vessel like structure will allow for the equal distribution of pressure to all parts of the body which will keep swelling from occurring.
